(19) United States
(12) Patent Application Publication
(10) Pub. No.: US 2017/0118770 A1
(43) Pub. Date: Apr. 27, 2017

(54) METHODS AND APPARATUS FOR SELECTING ENHANCED DISTRIBUTED CHANNEL ACCESS PARAMETERS FOR MULTI-USER TRANSMISSIONS

(71) Applicant: QUALCOMM Incorporated, San Diego, CA (US)

(72) Inventors: George Cherian, San Diego, CA (US); Simone Merlin, San Diego, CA (US); Gwendolyn Denise Barriac, Encinitas, CA (US); Alfred Asterjadhi, San Diego, CA (US)

(21) Appl. No.: 15/285,413

(22) Filed: Oct. 4, 2016

Related U.S. Application Data
(60) Provisional application No. 62/246,244, filed on Oct. 26, 2015.

(51) Int. Cl. H04W 74/08; H04B 7/04

(52) U.S. Cl. CPC H04W 74/08; H04B 7/0452; H04W 88/08

(57) ABSTRACT

In some aspects, a method for configuring channel access parameters in a wireless communication system includes determining, at an access point, a number of a plurality of stations instructed to transmit a concurrent uplink communication. The method further includes selecting, at the access point, an enhanced distributed channel access (EDCA) parameter based on the number of the plurality of stations that are instructed to transmit the concurrent uplink communication.

### CROSS-REFERENCE TO RELATED APPLICATION INFORMATION

The present application for patent claims priority to Provisional Application No. 62/246,244 entitled “METHODS AND APPARATUS FOR SELECTING ENHANCED DISTRIBUTED CHANNEL ACCESS PARAMETERS FOR MULTI-USER TRANSMISSIONS” filed Oct. 26, 2015, which is expressly incorporated by reference herein.

### BACKGROUND

Field

The present application relates generally to wireless communications, and more specifically to methods and apparatuses for selecting enhanced distributed channel access (EDCA) parameters for multi-user (MU) transmissions.

Background

Communications networks are used to exchange messages among devices.

Wireless networks are often preferred when the network elements are mobile and thus have dynamic connectivity needs, or if the network architecture is formed in an ad hoc, rather than fixed, topology. The devices in a wireless network may transmit/receive information based on channel access protocols such as enhanced distributed channel access (EDCA). EDCA defines separate data traffic access categories, which may include best effort, background, video and voice over wireless local access network (WLAN) (VoWLAN). For example, data traffic associated with transmission or reception of emails may be assigned a low priority class, and VoWLAN may be assigned a high priority class. Utilizing EDCA, high-priority data traffic has more opportunity of being sent than a low-priority data traffic because a station with high priority data traffic waits for less time before sending such a data packet, on average, than a station with low priority data traffic.

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infrared, optical, etc. frequency bands. Wireless networks advantageously facilitate user mobility and rapid field deployment when compared to fixed wired networks.

In order to address the issue of increasing bandwidth requirements that are demanded for wireless communications systems, different schemes are being developed to allow multiple user terminals (UTs) to communicate with a single access point by sharing the channel resources while achieving high data throughputs. With limited communication resources, it is desirable to reduce the amount of traffic passing between the access point and the multiple terminals. For example, when multiple terminals send uplink communications to the access point, it is desirable to minimize the amount of traffic to complete the uplink of all transmissions. Thus, there is a need for an improved protocol for uplink transmissions from multiple terminals.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved communications between access points and stations in a wireless network.

One aspect of the disclosure provides a method for configuring channel access parameters in a wireless communication system. The method includes determining, at an access point, a number of a plurality of stations instructed to transmit a concurrent uplink communication. The method further includes selecting, at the access point, an enhanced distributed channel access (EDCA) parameter based on the number of the plurality of stations that are instructed to transmit the concurrent uplink communication.

Another aspect of the disclosure provides an apparatus for configuring channel access parameters in a wireless communication system, the apparatus comprising at least a processor. The processor is configured determine a number of a plurality of stations instructed to transmit a concurrent uplink communication. The processor is further configured to select an enhanced distributed channel access (EDCA) parameter based on the number of the plurality of stations that are instructed to transmit the concurrent uplink communication.

Another aspect of the disclosure provides a non-transitory computer-readable medium. The medium comprises code that, when executed, causes an apparatus for configuring channel access parameters in a wireless communication system to perform a method. The method comprising determining, at an access point, a number of a plurality of stations instructed to transmit a concurrent uplink communication. The method further includes selecting, at the access point, an enhanced distributed channel access (EDCA) parameter based on the number of the plurality of stations that are instructed to transmit the concurrent uplink communication.

Another aspect of the disclosure provides an apparatus for configuring channel access parameters in a wireless communication system, including means for determining a number of a plurality of stations instructed to transmit a concurrent uplink communication. The apparatus further including means for means for selecting, at an access point, an enhanced distributed channel access (EDCA) parameter based on the number of the plurality of stations that are instructed to transmit the concurrent uplink communication.

### BRIEF DESCRIPTION OF THE DRAWINGS

FIG. 1 illustrates an example of a wireless communication system in which aspects of the present disclosure may be employed.

FIG. 2 illustrates various components that may be utilized in a wireless device that may be employed within the wireless communication system of FIG. 1.

FIG. 3 illustrates an exemplary implementation of an EDCA parameter set element.

FIG. 4 illustrates another exemplary implementation of an EDCA parameter set element.

FIG. 5 is a timing diagram showing an EDCA scheme that can be employed by a wireless device of FIG. 2 operating in the wireless communication system of FIG. 1.

FIG. 6 is a timing diagram showing another EDCA scheme for UL-MU transmissions that can be employed in the wireless communication system of FIG. 1.

FIG. 7 shows a flow chart of an exemplary method of wireless communication in a wireless communication system.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of wireless local area networks (WLANs). A WLAN can be used to interconnect nearby devices together, employing widely used networking protocols. The various aspects described herein may apply to any communication standard, such as a wireless protocol.

In some aspects, wireless signals can be transmitted according to a high-efficiency 802.11 protocol using orthogonal frequency-division multiplexing (OFDM), direct-sequence spread spectrum (DSSS) communications, a combination of OFDM and DSSS communications, or other schemes. In some aspects, the high-efficiency 802.11 protocol may comprise the IEEE 802.11ax protocol or future protocols. Implementations of the high-efficiency 802.11 protocol can be used for Internet access, sensors, metering, smart grid networks, or other wireless applications. Advantageously, aspects of certain devices implementing the high-efficiency 802.11 protocol using the techniques disclosed herein may include allowing for increased peer-to-peer services (for example, Miracast, WiFi Direct Services, Social WiFi, etc.) in the same area, supporting increased per-user minimum throughput requirements, supporting more users, providing improved outdoor coverage and robustness, and/or consuming less power than devices implementing other wireless protocols.

In some implementations, a WLAN includes various devices which are the components that access the wireless network. For example, there can be two types of devices: access points (“APs”) and clients (also referred to as stations, or “STAs”). In general, an AP may serve as a hub or base station for the WLAN and an STA serves as a user of the WLAN. For example, an STA can be a laptop computer, a personal digital assistant (PDA), a mobile phone, etc. In an example, an STA connects to an AP via a WiFi (for example, IEEE 802.11 protocol) compliant wireless link to obtain general connectivity to the Internet or to other wide area networks. In some implementations an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein can be incorporated into a phone (for example, a cellular phone or smartphone), a computer (for example, a laptop), a portable communication device, a headset, a portable computing device (for example, a personal data assistant), an entertainment device (for example, a music or video device, or a satellite radio), a gaming device or system, a global positioning system device, or any other suitable device that is configured to communicate via a wireless medium.

As discussed above, certain of the devices described herein may implement a high-efficiency 802.11 standard, for example. Such devices, whether used as an STA or AP or other device, can be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (for example, for use with hotspots), or to implement machine-to-machine communications.

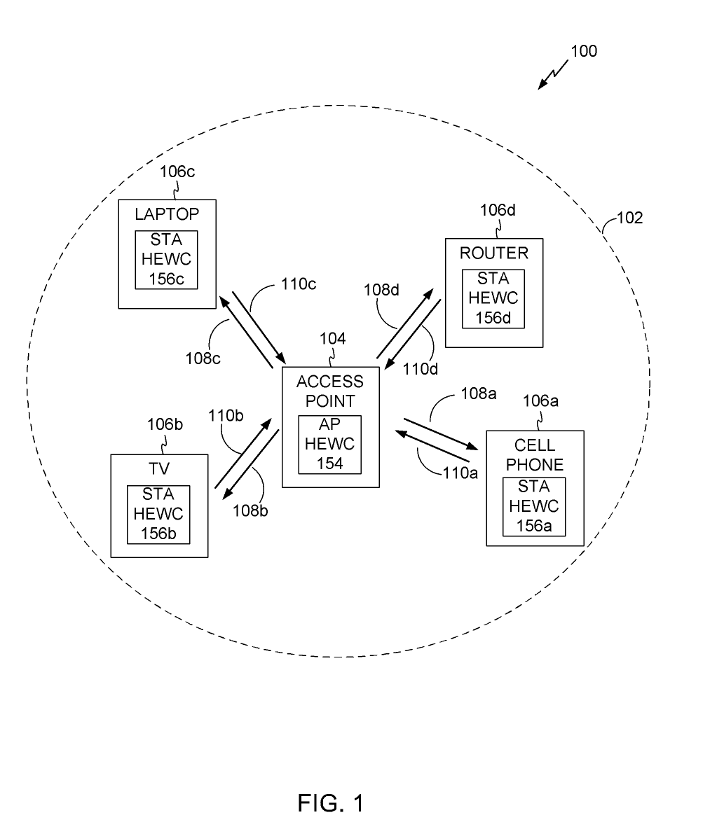

FIG. 1 shows an exemplary wireless communication system 100 in which aspects of the present disclosure can be employed. The wireless communication system 100 may operate pursuant to a wireless standard, for example a high-efficiency 802.11 standard. The wireless communication system 100 may include an AP 104, which communicates with STAs 106a-d.

A variety of processes and methods can be used for transmissions in the wireless communication system 100 between the AP 104 and the STAs 106. For example, signals can be sent and received between the AP 104 and the STAs 106 in accordance with OFDM/OFDMA or multi-user multiple input multiple output (MU-MIMO) techniques. If this is the case, the wireless communication system 100 can be referred to as an OFDM/OFDMA or an MU-MIMO system. Alternatively, signals can be sent and received between the AP 104 and the STAs 106 in accordance with code division multiple access (CDMA) techniques. If this is the case, the wireless communication system 100 can be referred to as a CDMA system.

A communication link that facilitates transmission from the AP 104 to one or more of the STAs 106 can be referred to as a downlink (DL) 108, and a communication link that facilitates transmission from one or more of the STAs 106 to the AP 104 can be referred to as an uplink (UL) 110. Alternatively, a downlink 108 can be referred to as a forward link or a forward channel, and an uplink 110 can be referred to as a reverse link or a reverse channel.

The AP 104 may act as a base station and provide wireless communication coverage in a basic service area (BSA) 102. The AP 104 along with the STAs 106 associated with the AP 104 and that use the AP 104 for communication can be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106.

In some aspects, a STA 106 can be required to associate with the AP 104 in order to send communications to and/or receive communications from the AP 104. In one aspect, information for associating is included in a broadcast by the AP 104. To receive such a broadcast, the STA 106 may, for example, perform a broad coverage search over a coverage region. A search may also be performed by the STA 106 by sweeping a coverage region in a lighthouse fashion, for example. After receiving the information for associating, the STA 106 may transmit a reference signal, such as an association probe or request, to the AP 104. In some aspects, the AP 104 may use backhaul services, for example, to communicate with a larger network, such as the Internet or a public switched telephone network (PSTN).

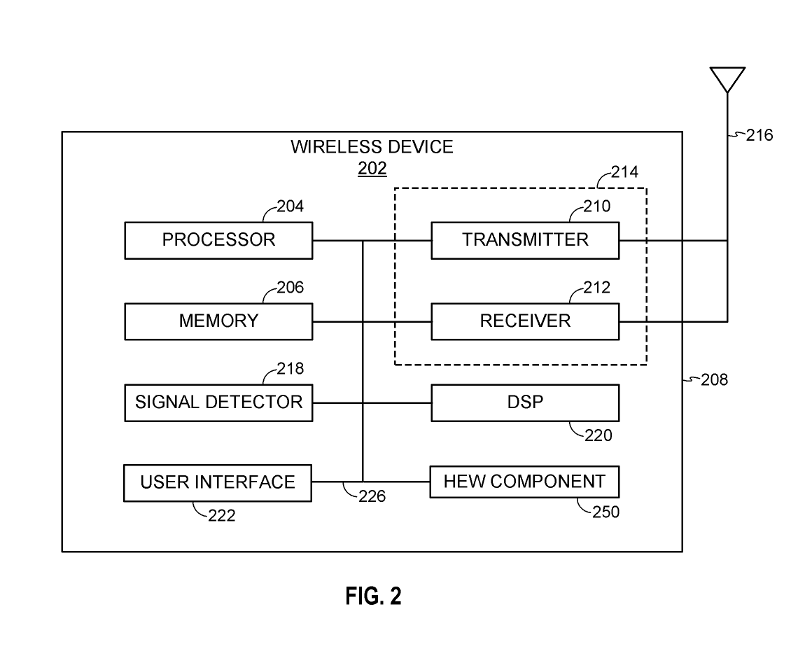

In an embodiment, the AP 104 includes an AP high-efficiency wireless component (HEWC) 154. The AP HEWC 154 may perform some or all of the operations described herein to enable communications between the AP 104 and the STAs 106 using the high-efficiency 802.11 protocol. The functionality of some implementations of the AP HEWC 154 is described in greater detail below with respect to FIGS. 2B, 3, and 4.

Alternatively or in addition, the STAs 106 may include a STA HEWC 156. The STA HEWC 156 may perform some or all of the operations described herein to enable communications between the STAs 106 and the AP 104 using the high-efficiency 802.11 protocol.

Generally, wireless networks that use a regular 802.11 protocol (for example, 802.11ax, 802.11ah, 802.11ac, 802.11a, 802.11b, 802.11g, 802.11n, etc.) operate under a carrier sense multiple access (CSMA) mechanism for medium access. According to CSMA, devices sense the medium and only transmit when the medium is sensed to be idle. Thus, if the AP 104 and/or STAs 106a-d are operating according to the CSMA mechanism and a device in the BSA 102 (for example, the AP 104) is transmitting data, then in some aspects APs and/or STAs 106 outside of the BSA 102 may not transmit over the medium even though they are part of a different BSA.

The use of the CSMA mechanism then creates inefficiencies because some APs or STAs 106 outside of a BSA can be able to transmit data without interfering with a transmission made by an AP or STA in the BSA. As the number of active wireless devices continues to grow, the inefficiencies can begin to significantly affect network latency and throughput. For example, significant network latency issues may appear in apartment buildings, in which each apartment unit may include an access point and associated stations. In fact, each apartment unit may include multiple access points, as a resident may own a wireless router, a video game console with wireless media center capabilities, a television with wireless media center capabilities, a cell phone that can act like a personal hot-spot, and/or the like. Correcting the inefficiencies of the CSMA mechanism may then be vital to avoid latency and throughput issues and overall user dissatisfaction.

Such latency and throughput issues may not be confined to residential areas. For example, multiple access points can be located in airports, subway stations, and/or other densely-populated public spaces. Currently, WiFi access can be offered in these public spaces, but for a fee. If the inefficiencies created by the CSMA mechanism are not corrected, then operators of the wireless networks may lose customers as the fees and lower quality of service begin to outweigh any benefits.

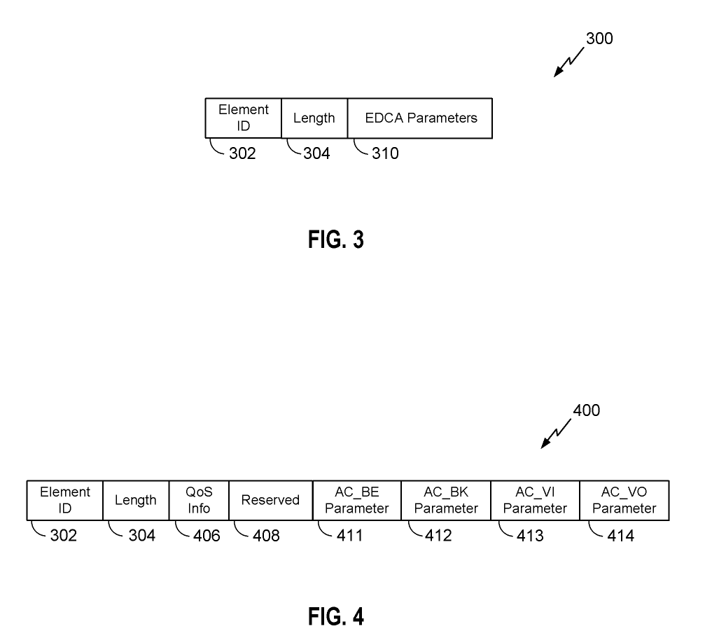

Accordingly, the high-efficiency 802.11 protocol described herein may allow for devices to operate under a modified mechanism that minimizes these inefficiencies and increases network throughput. Such a mechanism is described below with respect to FIGS. 3-7. Additional aspects of the high-efficiency 802.11 protocol are described below with respect to FIGS. 3-7.

FIG. 2 illustrates various components that may be utilized in a wireless device 202 that may be employed within the wireless communication system 100. The wireless device 202 is an example of a device that may be configured to implement various aspects described herein. For example, the wireless device 202 may comprise the AP 104 or any one of the wireless devices 106a-106d.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include non-transitory machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas, which may be utilized during MIMO communications, for example.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a data unit for transmission. In some aspects, the data unit may comprise a physical layer data unit (PPDU). In some aspects, the PPDU is referred to as a packet.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The wireless devices 202 may further comprise a high-efficiency wireless (HEW) component 250 in some aspects. The HEW component 250 may comprise the AP HEWC 154 and/or the STA HEWC 156. As described herein, the HEW component 250 may enable APs and/or STAs 106 to use a modified mechanism that minimizes the inefficiencies of the CSMA mechanism (for example, enables concurrent communications over the medium in situations in which interference would not occur). In some aspects, the AP HEWC 154 may select an EDCA parameter based on the number of stations included in an UL-MU trigger frame. In other embodiments, the AP HEWC 154 may choose to select the EDCA parameters for MU transmissions, and not notify the STAs 106 in a trigger frame. In some aspects, the AP HEWC 154 may also generate the UL-MU trigger frame.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

In a wireless network, channel access parameters can be defined to control access to a transmission medium (e.g., a wireless network) by devices communicating via the wireless network. A transmission medium can also be termed as a transmission channel. Examples of channel access parameters can include (but are not limited to) parameters described as part of the enhanced distributed channel access (EDCA) parameters in the 802.11 industry standard (e.g., 802.11ax). Further examples of channel access parameters can include (but are not limited to) minimum contention window (CWmin), maximum contention window (CWmax), transmit opportunity (TXOP), transmission opportunity limit (TXOP limit), and arbitration inter frame space (AIFS), which may also be part of the EDCA parameters.

Certain aspects of the present disclosure support transmitting an uplink (UL) signal or packet 110 from multiple STAs 106 to the AP 104 or other device. In some embodiments, the UL signal 110 may be transmitted using multi-user MIMO (MU-MIMO). In some embodiments, the UL signal 110 may be transmitted UL-OFDMA. Alternatively, the UL signal 110 may be transmitted in a multi-carrier FDMA (MC-FDMA) or similar FDMA system (e.g., OFDMA). In some aspects, the MU-MIMO/OFDMA and MC-FDMA transmissions comprise concurrent UL transmissions from multiple STAs 106 to the AP 104 may be referred to as more generally, UL-MU communications or transmissions. In some embodiments, the AP 104 may define EDCA parameters to facilitate UL-MU transmissions. The EDCA parameters may be selected and transmitted from the AP 104 during association/re-association (e.g., as data in an association/re-association response message) or included in a beacon frame. In other aspects, the AP 104 may choose to select the EDCA parameters for MU transmissions, and not notify the STAs 106. In one embodiment the EDCA parameters may be defined in an IEEE 802.11 standard (e.g., 802.11ax). In another embodiment, the EDCA parameter may be enhanced from that defined in an IEEE 802.11 standard by appending one or more rules for an AP 104, a group of STAs 106, or a type of STAs 106.

The number of wireless devices 202 within the wireless communication system 100 and contending for the same wireless medium can impact the performance of the CSMA mechanism. As the number of devices operating within the network increases, the CSMA mechanism may not be able to adequately support transmissions for a dense network. In some aspects, UL-MU-MIMO or UL-OFDMA transmissions sent simultaneously from multiple STAs 106 to the AP 104 may create efficiencies in wireless communication. However, in some aspects, UL-MU-MIMO or UL-OFDMA transmissions may also contend with UL single user (SU) transmissions. When there are a large number of UL-SU transmissions or accesses of the medium, the AP 104 will need to compete against multiple UL-SU transmissions, which could lead to potential unfairness, decreased throughput, reduced access (and starvation in some cases) to UL-MU transmissions. For example, referring to FIG. 1, in some aspects, STAs 106a and 106b may transmit UL-SU signals 110a and 110b and STAs 106c and 106d may transmit UL-MU signals 110c and 110d. Each of the STAs 106a-d contends for channel access to transmit UL signals 110a-d. Such contention may be based on an EDCA parameter and/or an EDCA protocol as specified in an IEEE 802.11 standard (e.g., 802.11ah, or 802.11ac). In some embodiments, the UL-MU signals 110c and 110d (e.g., UL-MU-MIMO or UL-OFDMA transmissions) may be based on a UL-MU trigger frame sent by the AP 104 to the STAs 106c and 106d. In some aspects, the STAs 106c and 106d may be unable to transmit the UL-MU signals 110c and 110d for an extended period of time when the AP 104 cannot access the channel/medium due to the UL-SU signals 110a and 110b.

Embodiments described herein relate to the AP 104 selecting a different EDCA protocol and/or parameter for sending an UL-MU trigger frame than the EDCA protocol/parameter used for UL-SU transmissions 110a-b or for DL SU transmissions. In some aspects, the different EDCA protocol and/or parameter may comprise adjusting an EDCA parameter such that the AP 104 may access the medium more often for the UL-MU transmissions 110c-d than what is defined for UL-SU transmissions 110a-b or for DL SU transmissions. For example, in the absence of receiving an UL-MU trigger frame, each of the STAs 106 may contend for the medium with a certain contention window (CW). When the AP 104 is accessing the channel on behalf of, for example, N number of STAs 106 to send the UL-MU trigger frame, then the AP 104 can use a different CW that will be equivalent to N independent SU accesses.

In some embodiments, the AP 104 selects a first contention window (CW) based on the number of STAs and then selects a second CW based on a change in the number of the STAs. In such an embodiment, a size of the second CW can be smaller or larger than a size of the first CW.

In some embodiments, the AP 104 may advertise the EDCA parameter (e.g., CW) used for the trigger frame for UL-MU transmissions 110c-d (as a function of number of STAs 106 included in the UL-MU trigger frame), which could also be used by neighboring APs. In some aspects, the same metrics or EDCA parameter can also be applied to downlink (DL) MU transmissions 108.

FIG. 3 illustrates an exemplary implementation of an EDCA parameter set element 300. In some aspects, the AP 104 may advertise by transmitting the EDCA parameter set element 300. The EDCA parameter set element 300 includes an element identifier (ID) field 302, a length field 304, and an EDCA parameter field 310. In some aspects, the element ID field 302 identifies a type of element. In some aspects, the length field 304 indicates the length of the EDCA parameter set element 300.

In some aspects, the EDCA parameter field 310 indicates one or more parameters used for an UL-MU transmission such as 110c or 110d from FIG. 1. For example, the EDCA parameter field 310 may include an indication of a contention window (CW) size used for a trigger frame for UL-MU transmissions 110c-d. The CW size may be based on one or more of the number of STAs 106 the AP 104 plans to include in its UL-MU trigger frame, the average number of STAs 106 the AP 104 is able to schedule in the UL-MU trigger frame, or some other function of the number of STAs 106 being scheduled in the UL-MU trigger frame. In some aspects, the AP HEWC 154 of FIG. 1 and/or the HEW component 250 of FIG. 2 may be configured to select the EDCA parameter (e.g., CW size) based on one or more of the number of STAs 106 included in an UL-MU trigger frame, the average number of STAs 106 the AP 104 is able to schedule in the UL-MU trigger frame, or some other function of the number of STAs 106 being scheduled in the UL-MU trigger frame. In some embodiments, the UL-MU trigger frame may include instructions for the two or more STAs 106 receiving the UL-MU trigger frame to concurrently transmit an UL-MU communication (e.g., UL-MU signals 110c-d) to the AP 104 at a specific time.

FIG. 4 illustrates another exemplary implementation of an EDCA parameter set element 400. The EDCA parameter set element 400 is similar to and adapted from the EDCA parameter set element 300 of FIG. 3 and only differences between the EDCA parameter set element 300 and the EDCA parameter set element 400 are discussed herein for the sake of brevity. In some aspects, the AP 104 may transmit the EDCA parameter set element 400 in order to set the EDCA parameters (e.g., channel access parameters) for one or more STAs 106. The EDCA parameter set element 400 may comprise a quality of service (QoS) information (info) field 406, a reserved field 408, a best effort (BE) channel access parameter field 411, a background (BK) channel access parameter field 412, a video (VI) channel access parameter field 413, and a voice (VO) channel access parameter field 414. In some aspects, exemplary sizes in octets of each of the fields 302, 304, 406, 408, 411, 412, 413 and 414 may comprise 1, 1, 1, 1, 4, 4, 4, and 4, respectively. In some embodiments, EDCA parameters may be based on whether the UL-MU transmissions are to be transmitted using MU-MIMO or OFDMA. For example, the EDCA parameter set element 400 may indicate a first set of parameters for UL-MU-MIMO transmissions and a second set of parameters for UL-OFDMA transmissions. Similarly, in some embodiments, EDCA parameters may be based on the number of STAs 106 included in an UL-MU trigger frame. For example, the EDCA parameter set element 400 may indicate a first set of parameters for UL-MU transmissions triggering <N STAs 106 and a second set of parameters for UL-MU transmissions triggering >N STAs 106.

In some aspects, the EDCA parameter field 310 of FIG. 3 may comprise the fields 411, 412, 413 and 414 of the EDCA parameter set element 400. In some embodiments, one or more of the fields 411, 412, 413 and 414 may comprise access categories (ACs) that indicate a level of priority for channel access. In some aspects, one or more of the fields 411, 412, 413 and 414 may comprise an indication of a CW size. In some aspects, CW can be selected according to the traffic expected in each access category or be selected based on the number of STAs 106 the AP 104 plans to include in its UL-MU trigger frame. In some aspects, the CW size may be indicated by a minimum contention window (CWmin) and a maximum contention window (CWmax).

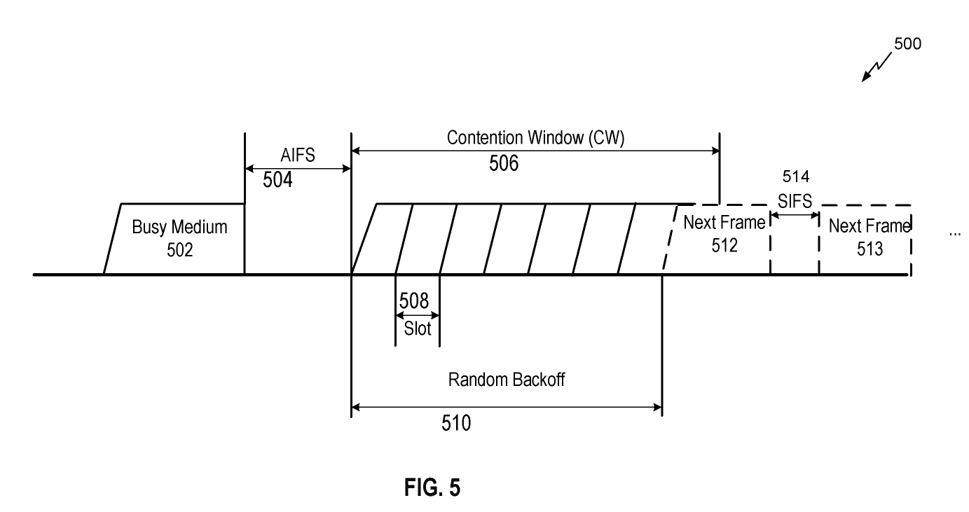

FIG. 5 is a timing diagram showing an EDCA scheme 500 that can be employed by a wireless device 202 of FIG. 2 operating in the wireless communication system 100 of FIG. 1. To avoid collisions, a wireless device 202 (e.g., AP 104) that has prepared a frame for transmission first senses the wireless medium. In some embodiments, the frame can be an UL-MU trigger frame. As shown in FIG. 5, the wireless device 202 can sense that the wireless medium is busy as shown by time interval 502. If the wireless medium is busy, the wireless device 202 defers for a time duration such as an arbitration inter frame space (AIFS) as shown by the AIFS time interval 504. In some aspects, the AIFS 504 may be dependent on an access category and a queue of the frame waiting transmission. Once the wireless device 202 has waited the AIFS 504, it may randomly or pseudo-randomly select a value for its random backoff timer. The random backoff timer value (shown by time interval 510) may comprise a time value within a time interval of the CW 506 (e.g., less than or equal to the number of slots 508 in the CW 506). The CW 506 may be divided into a number of time slots as shown by time slot 508. As shown in FIG. 5, the CW 506 comprises 8 time slots 508.

After selecting a value for the time interval 510, the wireless device 202 further defers and senses the wireless medium during each slot 508 of the time interval 510. If the wireless medium continues to be idle for the duration of the time interval 510, the wireless device 202 can transmit a frame as indicated by the next frame 512. If the wireless device 202 senses that the wireless medium is busy during any of the slots 508 of the time interval 510, the wireless device 202 waits until the medium is idle, defers for another AIFS period, and then resumes the random backoff timer value 510. For example, as shown, the time interval 510 can be pseudo-randomly determined to be seven slots 508. After deferring for 3 slots 508, the wireless device 202 can sense that the wireless medium is busy. In response, the wireless device 202 waits until the wireless medium becomes idle, defers for an AIFS period (AIFS 504), and then resumes counting down for 4 additional slots 508. Accordingly, multiple devices attempting to transmit may select a different number of slots 508 such that each will defer for a different amount of time to prevent collisions and allow each wireless device 202 to transmit prepared frames.

In various embodiments, the wireless device 202 can transmit one or more additional frames 513 after winning contention for (e.g., gaining access to) the wireless medium. The additional frames 513 can be separated by a short inter-frame space (SIFS) 514. The number of additional frames 513 can be limited to a maximum number of N1. In various embodiments, N1 can be between around 1 and around 10, between around 2 and around 5, and in some aspects, around 3. Additionally or alternatively, the total time occupied by transmission of the frames can be limited to a maximum of T1. In various embodiments, T1 can be between around 1 ms and around 10 ms, between around 0.75 ms and 1.25 ms, and in some aspects, around 1 ms.

As discussed above, the size of the CW 506 can be a function of a number of STAs 106 included in an UL-MU trigger frame. In some aspects, a CW used for sending the UL-MU trigger frame (CW_{MU}) that contains N number of UL STAs 106 (N_{Ul-STAs}) is a function of a CW 506 for single user transmissions (CW_{SU}) and N_{UL-STAs}. One example of a linear scaling is shown by the equation 1: CW_{MU}=CW_{SU}*k/N_{UL-STAs}, where k is a constant.

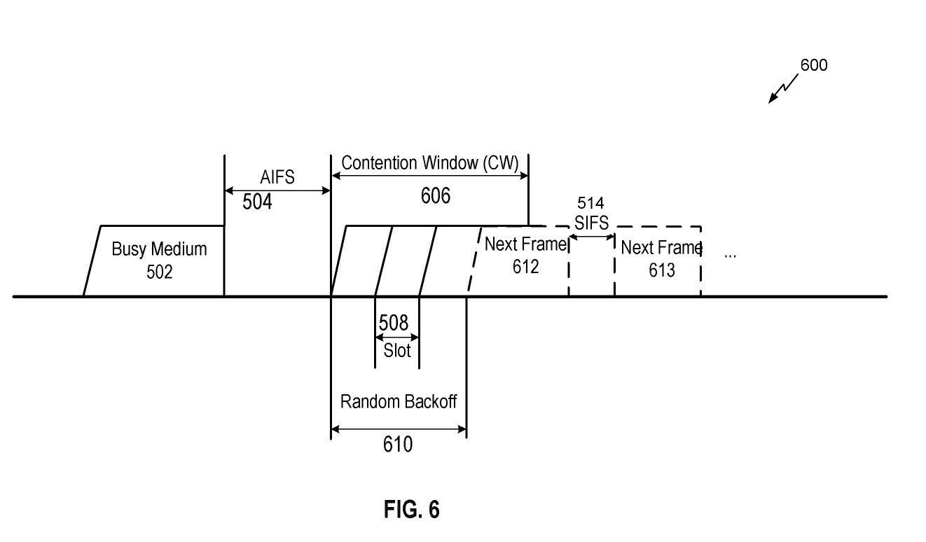

For example, as shown in FIG. 5, the CW 506 comprises 8 time slots 508 and may be indicative of a CW 506 size for a UL-SU transmission (e.g., CW_{SU}). FIG. 6 is a timing diagram showing another EDCA scheme 600 for UL-MU transmissions that can be employed in the wireless communication system 100 of FIG. 1. The EDCA scheme 600 is similar to and adapted from the EDCA scheme 500 of FIG. 5. Only differences between the EDCA scheme 500 and the EDCA scheme 600 are discussed herein for the sake of brevity.

In some embodiments, a wireless device 202 or an AP 104 may set a CW 606 based on the number of STAs 106 that are instructed to transmit a concurrent uplink communication (e.g., number of STAs 106 included in an UL-MU trigger frame). In the EDCA scheme 600, the AP 104 or wireless device 202 sets a CW 606. FIG. 6 illustrates an example where the number of STAs 106 included in an UL-MU trigger frame is 2. As shown, the CW 606 comprises 4 time slots 508 and a random backoff timer value indicated by time interval 610 which comprises 3 time slots 508. The CW size for CW 606 may be based on the number of UL-MU STAs 106 (e.g., STAs 106c-d). For example, referring back to equation 1 above, CW_{MU}=CW_{SU}*k/N_{UL-STAs} and selecting 8 for CW_{SU} (as illustrated in FIG. 5), 2 for N_{UL-STAs}, and 1 for the constant k, results in CW_{MU}=8*(½)=4 time slots 508 for CW 606 (as shown in FIG. 6). In other embodiments, the value of CW_{MU} may comprise different values for different values of the constant k and different values of CW_{SU}. Thus, the AP 104 or wireless device 202 may have a CW 606 half the size of that for a UL-SU transmission and may attempt to access the medium twice as often as a device attempting to send a UL-SU transmission. Accordingly, the AP 104 may have a higher priority to the medium for its MU-UL transmission than devices attempting to send UL-SU transmissions.

In some aspects, the AP 104 may then access the medium after the time interval 610 and transmit a next frame 612 and/or a next frame 613. In some embodiments, one or both of the next frames 612 and 613 may comprise a UL-MU trigger frame. In response to receiving the UL-MU trigger frame, the STAs 106 receiving the UL-MU trigger frame may then concurrently transmit their UL-MU transmissions to the AP 104. Because the AP 104 has taken into account the STAs 106 included in the UL-MU trigger frame, the STAs 106 receiving the UL-MU trigger frame may transmit their UL-MU transmissions with a reduced probability of collisions or interference from UL-SU transmissions and with increased efficiency. Additionally, in some embodiments, the AP 104 may adjust the selected EDCA parameter based on a change in the number of STAs 106 that are instructed to transmit a concurrent uplink communication. For example, the AP 104 may adjust the CW 606 time period from 4 time slots 508 to 2 time slots 508 when the number of STAs 106 included in an UL-MU trigger frame is increased from 2 to 4.

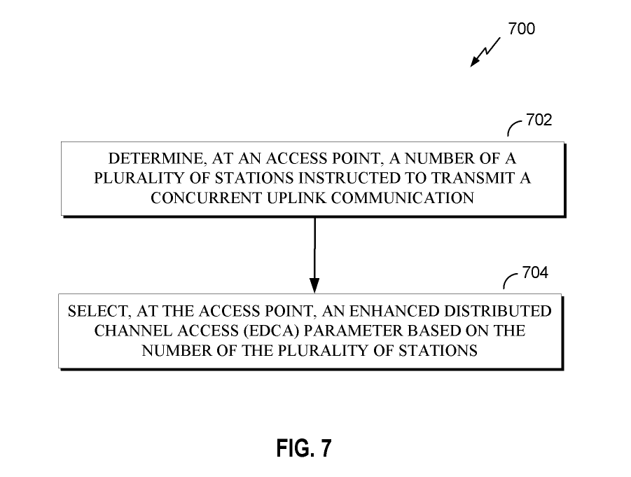

FIG. 7 shows a flow chart of an implementation of a method 700 of wireless communication in a wireless communication system. The method 700 may be used to generate and/or transmit any of the EDCA parameters or EDCA parameter set elements 300 or 400 described in connection with FIGS. 3-4. In some aspects, the EDCA parameter or the EDCA parameter set element 300 or 400 may be transmitted by the AP 104. In addition, the wireless device 202 shown in FIG. 2 may represent a more detailed view of the AP 104, as described above. Thus, in one implementation, one or more of the steps in method 700 may be performed by, or in connection with, a processor and/or transmitter, such as the processor 204, transmitter 210, and HEW component 250 of FIG. 2, although those having ordinary skill in the art will appreciate that other components may be used to implement one or more of the steps described herein. Although the method steps may be described as occurring in a certain order, the steps can be reordered, omitted, and/or additional steps may be added.

At block 702, the method 700 may include determining, at the AP 104, a number of a plurality of STAs 106 instructed to transmit a concurrent uplink communication. Such determining may be performed by the processor 204 or the HEW component 250 of the wireless device 202 shown in FIG. 2. At block 704, the method 700 selects, at the AP 104, an enhanced distributed channel access (EDCA) parameter based on the number of the plurality of STAs 106. For example, the AP 104 may select an EDCA parameter (e.g., contention window) based on the number of STAs 106 (e.g., STAs 106c-d) that may be instructed to transmit an UL-MU transmission. Such selection may be performed by the processor 204 or the HEW component 250 of the wireless device 202 shown in FIG. 2.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

In an aspect, the wireless device 202 can include means for determining a number of a plurality of STAs 106 instructed to transmit a concurrent uplink communication. In various aspects, the means for determining can be implemented by one or more of the processor 204 (FIG. 2), the memory 206 (FIG. 2), and the HEW component 250 (FIG. 2). The HEW component 250 may comprise the AP HEWC 154 and/or the STA HEWC 156. The AP HEWC 154 may perform some or all of the operations described herein to enable communications between the AP 104 and the STAs 106 using the high-efficiency 802.11 protocol. Alternatively or in addition, the STA HEWC 156 may perform some or all of the operations described herein to enable communications between the STAs 106 and the AP 104 using the high-efficiency 802.11 protocol.

In an aspect, the wireless device 202 can further include means for selecting an enhanced distributed channel access (EDCA) parameter based on the number of the plurality of STAs 106 that are instructed to transmit a concurrent uplink communication. In various aspects, the means for selecting can be implemented by one or more of the processor 204 (FIG. 2), the memory 206 (FIG. 2), and the HEW component 250 (FIG. 2). The HEW component 250 may comprise the AP HEWC 154 and/or the STA HEWC 156. The AP HEWC 154 may perform some or all of the operations described herein to enable communications between the AP 104 and the STAs 106 using the high-efficiency 802.11 protocol. Alternatively or in addition, the STA HEWC 156 may perform some or all of the operations described herein to enable communications between the STAs 106 and the AP 104 using the high-efficiency 802.11 protocol.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for configuring channel access parameters in a wireless communication system, the method comprising:
determining, at an access point, a number of a plurality of stations instructed to transmit a concurrent uplink communication; and
selecting, at the access point, an enhanced distributed channel access (EDCA) parameter based on the number of the plurality of stations that are instructed to transmit the concurrent uplink communication.

2. The method of claim 1, further comprising transmitting the selected EDCA parameter in an EDCA parameter set element.

3. The method of claim 2, wherein the EDCA parameter set element comprises a first set of parameters for UL-MU-MIMO transmissions and a second set of parameters for UL-OFDMA transmissions, the selected EDCA parameter being part of the first set of parameters or the second set of parameters.

4. The method of claim 2, wherein the EDCA parameter set element further comprises an element identifier (ID) field, the element identifier (ID) field identifying a type of element.

5. The method of claim 2, wherein the EDCA parameter set element further comprises a length field, the length field identifying a length of the EDCA parameter set element.

6. The method of claim 1, wherein the selected EDCA parameter comprises a contention window (CW).

7. The method of claim 6, wherein selecting the EDCA parameter comprises:
selecting a first contention window (CW) based on the number of the plurality of stations; and
selecting a second CW based on a change in the number of the plurality of stations, wherein a size of the second CW is smaller than a size of the first CW.

8. The method of claim 6, wherein a size of the CW is a function of the number of the plurality of stations.

9. The method of claim 1, wherein the selected EDCA parameter indicates a parameter used for an UL-MU transmission.

10. The method of claim 1, wherein the selected EDCA parameter comprises an access category.

11. The method of claim 1, wherein selecting the EDCA parameter comprises:
selecting a first EDCA parameter based on the number of the plurality of stations; and
selecting a second EDCA parameter based on a change in the number of the plurality of stations, wherein the second EDCA parameter has a higher priority than the first EDCA parameter.

12. The method of claim 1, further comprising transmitting a first message to the plurality of stations, the first message including instructions for the plurality of stations to transmit the concurrent uplink communication.

13. The method of claim 12, further comprising receiving the concurrent uplink communication from the plurality of stations.

14. The method of claim 1, further comprising adjusting the selected EDCA parameter based on a change in the number of the plurality of stations that are instructed to transmit the concurrent uplink communication.

15. An apparatus for configuring channel access parameters in a wireless communication system, the apparatus comprising:
a processor configured to:
determine a number of a plurality of stations instructed to transmit a concurrent uplink communication; and
select an enhanced distributed channel access (EDCA) parameter based on the number of the plurality of stations that are instructed to transmit the concurrent uplink communication.

16. The apparatus of claim 15, wherein the processor is further configured to transmit the selected EDCA parameter in an EDCA parameter set element.

17. The apparatus of claim 15, wherein the EDCA parameter set element comprises a first set of parameters for UL-MU-MIMO transmissions and a second set of parameters for UL-OFDMA transmissions, the selected EDCA parameter being part of the first set of parameters or the second set of parameters.

18. The apparatus of claim 17, wherein the EDCA parameter set element further comprises an element identifier (ID) field, the element identifier (ID) field identifying a type of element.

19. The apparatus of claim 17, wherein the EDCA parameter set element further comprises a length field, the length field identifying a length of the EDCA parameter set element.

20. The apparatus of claim 15, wherein the selected EDCA parameter comprises a contention window (CW).

21. The apparatus of claim 20, wherein the processor is further configured to:
select a first contention window (CW) based on the number of the plurality of stations; and
select a second CW based on a change in the number of the plurality of stations, wherein a size of the second CW is smaller than a size of the first CW.

22. The apparatus of claim 15, wherein a size of the CW is a function of the number of the plurality of stations.

23. The apparatus of claim 15, wherein the selected EDCA parameter indicates a parameter used for an UL-MU transmission.

24. The apparatus of claim 15, wherein the selected EDCA parameter comprises an access category.

25. The apparatus of claim 15, wherein the processor is further configured to:
select a first EDCA parameter based on the number of the plurality of stations; and
select a second EDCA parameter based on a change in the number of the plurality of stations, wherein the second EDCA parameter has a higher priority than the first EDCA parameter.

26. The apparatus of claim 15, further comprising a transmitter configured to transmit a first message to the plurality of stations, the first message including instructions for the plurality of stations to transmit the concurrent uplink communication.

27. The apparatus of claim 15, further comprising a receiver configured to receive the concurrent uplink communication from the plurality of stations.

28. The apparatus of claim 16, wherein the processor is further configured to adjust the selected EDCA parameter based on a change in the number of the plurality of stations that are instructed to transmit the concurrent uplink communication.

29. A non-transitory computer-readable medium comprising code, that when executed, causes an apparatus for configuring channel access parameters in a wireless communication system to perform a method, the method comprising:
determining, at an access point, a number of a plurality of stations instructed to transmit a concurrent uplink communication; and
selecting, at the access point, an enhanced distributed channel access (EDCA) parameter based on the number of the plurality of stations that are instructed to transmit the concurrent uplink communication.

30. An apparatus for configuring channel access parameters in a wireless communication system, the apparatus comprising:
means for determining, at an access point, a number of a plurality of stations instructed to transmit a concurrent uplink communication; and
means for selecting, at an access point, an enhanced distributed channel access (EDCA) parameter based on the number of the plurality of stations that are instructed to transmit the concurrent uplink communication.
